(19) United States
(12) Patent Application Publication
(10) Pub. No.: US 2014/0240861 A1
(43) Pub. Date: Aug. 28, 2014

(54) Luminance Filtering Assembly

(71) Applicant: Wayne Fujisaka, Las Vegas, NV (US)

(72) Inventor: Wayne Fujisaka, Las Vegas, NV (US)

(21) Appl. No.: 13/660,127

(22) Filed: Oct. 25, 2012

(51) Int. Cl. B60J 3/02

(52) U.S. Cl. CPC B60J 3/0286
USPC 359/892

(57) ABSTRACT

A luminance filtering assembly provides a translucent plate that extends from a vehicle visor to minimize the glare from sunlight and glares without restricting a line of sight. The translucent plate includes a tint. The translucent plate attaches to the visor through a strap that adjusts vertically and horizontally to accommodate for different user heights, lines of sight, movement, and intensity of glares. A fastener clamps down on both the visor and a visor end of the strap to secure a desired height for the translucent plate for an extended position. For storage, the fastener clamps the translucent portion against the visor for storage to form a retracted position. An adhesive portion on the translucent portion also serves to secure the translucent plate to the visor in the retracted position. A slot in the translucent plate receives one end of the strap, sliding laterally for horizontal adjustments.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to filtering luminance. More particularly, one or more embodiments of the invention relate to filtering luminance on a vehicle windshield.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a visor is a surface that protects the eyes, such as shading them from the sun or other bright light or protecting them from objects. One visor is a device in a vehicle that the driver or front passenger can lower over part of the windshield to block the sun.

Typically, a glare is difficulty seeing in the presence of bright illumination such as direct or reflected sunlight or artificial light such as oncoming motorist headlamps at night. Because of this, some cars include mirrors with automatic anti-glare functions.

Typically, the glare is caused by a significant ratio of luminance between the object that which is being looked at and the glare source. The glare can cause distractions to a driver.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary luminance filtering assembly in use, in accordance with an embodiment of the present invention;

FIG. 2 illustrates a detailed perspective view of an exemplary luminance filtering assembly in an exemplary extended position with an exemplary fastener detached, in accordance with an embodiment of the present invention;

FIGS. 3A and 3B illustrate detailed perspective views of an exemplary luminance filtering assembly, in accordance with an embodiment of the present invention, where FIG. 3A illustrates an exemplary luminance filtering assembly extended a short vertical distance from an exemplary visor, and FIG. 3B illustrates an exemplary luminance filtering assembly extended a longer vertical distance from an exemplary visor;

FIGS. 4A and 4B illustrate detailed perspective views of an exemplary luminance filtering assembly, in accordance with an embodiment of the present invention, where FIG. 4A illustrates an exemplary luminance filtering assembly adjusted horizontally to the left, and FIG. 4B illustrates an exemplary luminance filtering assembly adjusted horizontally to the right;

FIG. 5 illustrates a detailed perspective view of an exemplary luminance filtering assembly in a retracted position, in accordance with an embodiment of the present invention;

FIG. 6 illustrates a close up view of an exemplary translucent portion end of an exemplary strap looped around an exemplary slot, in accordance with an embodiment of the present invention;

FIGS. 7A and 7B illustrate detailed perspective views of an exemplary fastener, in accordance with an embodiment of the present invention, where FIG. 7A illustrates an exemplary fastener in an open position, and FIG. 7B illustrates an exemplary fastener in a closed position;

FIGS. 8A and 8B illustrate detailed perspective views of an exemplary visor strap, in accordance with an embodiment of the present invention, where FIG. 8A illustrates an exemplary visor strap in an open position, and FIG. 8B illustrates an exemplary visor strap in a closed position wrapped around an exemplary visor; and

FIGS. 9A and 9B illustrate detailed perspective views of an exemplary luminance filtering assembly without a strap, in accordance with an embodiment of the present invention, where FIG. 9A illustrates an exemplary luminance filtering assembly adjusted horizontally to the right, and FIG. 9B illustrates an exemplary luminance filtering assembly adjusted horizontally to the left.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of luminance filtering assemblies that may be provided by preferred embodiments of the present invention. In one embodiment of the present invention, the luminance filtering assembly 100 may provide a translucent portion 102 that extends from a visor 210 on a vehicle for helping to minimize the glare from sunlight or other luminance without restricting a line of sight. The translucent portion may include a film of tint for restricting the glare and luminance. In some embodiments, the translucent portion may join with the visor through a strap 106 that supports the translucent portion. In this manner, the translucent portion may be adjusted to accommodate for different user heights, lines of sight, movement, and intensity of glares from luminance. In one embodiment of the present invention, a fastener 202 may clamp down on the visor, and on a visor end 204 of the strap to secure a desired vertical length for the translucent portion. In this manner, the translucent portion may position into an extended position 212 for use.

For storage, the fastener may press the translucent portion against the visor in a retracted position 502. The translucent portion may also utilize an adhesive portion 208 to secure to a visor strap 302, which may wrap around the visor. The adhering portion may join with a compatible area of the visor strap to further secure the translucent portion against the visor. In one embodiment, a slot 104 in the translucent portion may receive a translucent portion end 206 of the strap. The translucent portion end may include a loop that is configured to wrap through the slot. In this manner, the translucent portion may be adjusted horizontally.

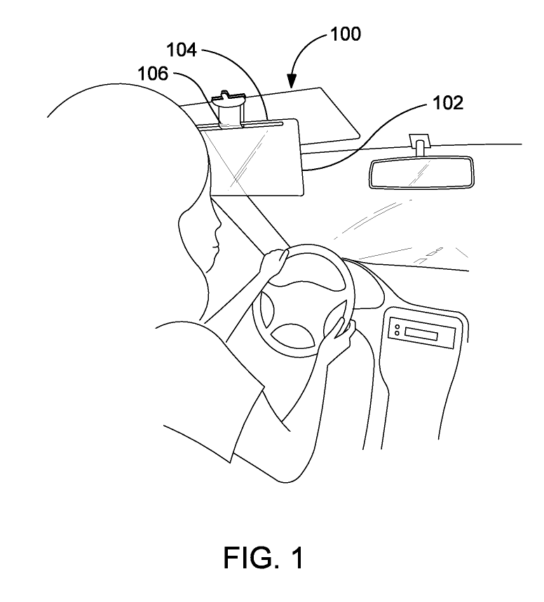

FIG. 1 illustrates a detailed perspective view of an exemplary luminance filtering assembly in use, in accordance with an embodiment of the present invention. In the present embodiment, the luminance filtering assembly may provide a translucent portion that extends from a visor on a vehicle for helping to minimize the glare from sunlight or other luminance without restricting a line of sight. Those skilled in the art, in light of the present teachings will recognize that the visor may also be in an extended position, whereby the translucent portion provides additional area on the vehicle windshield for filtering the luminance. However, in other embodiments, the translucent portion may filter luminance for a variety of transparent surfaces, including, without limitation, a window, a section of glass, and a building. The translucent portion may include tint for helping to restrict the glare from luminance, including, without limitation, sunlight, street lights, snow, ice, reflections, and oncoming motorists. In some embodiments, the tint may include a rating of 20% visible light transmission. However, in other embodiments, lesser or greater tinting may be utilized. Those skilled in the art, in light of the present teachings will recognize that excessive tinting may violate ordinances and laws. A visible light transmission between 15% and 25% may be acceptable in most areas. The present embodiment is primarily designed for front windows, however, alternatively applications could include use on side and rear glass. For side glass applications, it is contemplated, for example, that the user would lower the window, extend the strap that is connected to the tinted piece through the window a little, and then roll up the window. As for a back window applications, it is contemplated, for example, that the user would need another way to secure the product. Possibly suction cups or hook and loop (e.g., Velcro™) straps could be used to hold it in place for use on rear glass. In one embodiment, the translucent portion may include dimensions of 8″×5″×¼″. However, in other embodiments, a larger or smaller translucent portion may be utilized.

In one embodiment of the present invention, the translucent portion may include shatter proof material, translucent material, including, without limitation polycarbonate, acrylonitrile butadiene styrene, acrylic, or a combination of the above. In many practical applications, it is contemplated, for example, that any suitable type of plastic that is shatter proof, can be tinted and does not distort view could be used. By way of example, and not limitation, additional potential plastics may include polyvinyl chloride (PVC), polystyrene (PS) and polyethylene terephthalate (PET), and even tempered glass might be used. Those skilled in the art, in light of the present teachings will recognize that a sudden jolt from an accident may not shatter such materials, whereby the risk for cuts and eye damage may be minimized. In one alternative embodiment, the translucent portion may include side wings that extend angularly from a base of the translucent portion. Those skilled in the art, in light of the present teachings will recognize that the side wings may provide protection from sight-impairing sunlight encountered as the vehicle orients into different directions. turn and change principal direction. The side wings may be permanently fixed at a variety of angles, and/or may be hinged to allow personalized adjustment.

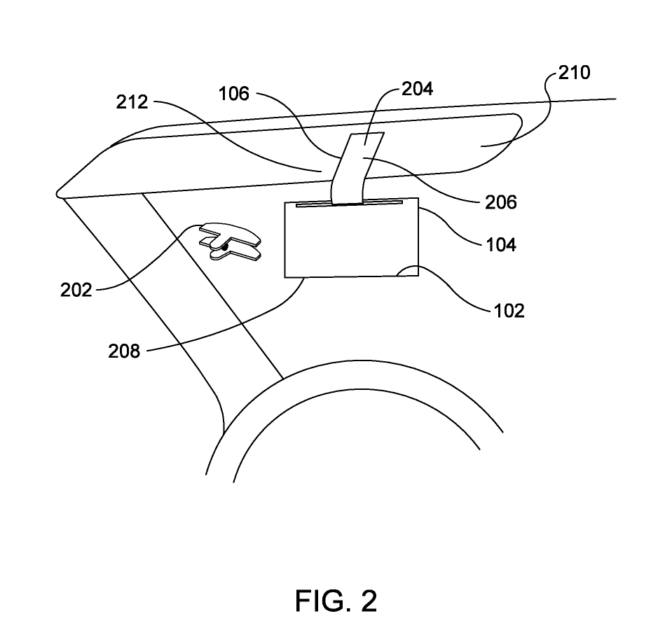

FIG. 2 illustrates a detailed perspective view of an exemplary luminance filtering assembly in an exemplary extended position with an exemplary fastener detached, in accordance with an embodiment of the present invention. In the present embodiment, the translucent portion may join with the visor in either the retracted position, or the extended position. The translucent portion may utilize the fastener in either position. The translucent portion may adjustably extend beneath the visor, and also adjust horizontally to compensate for variables, including, without limitation, a moving vehicle, a rising/setting sun, change in vehicle direction, various user heights, and oncoming motorists. In some embodiments, the fastener may fasten the translucent portion in the extended position to a desired height. The fastener may be detached from the visor, and the strap extended until the desired height for the translucent portion is achieved. Those skilled in the art, in light of the present teachings will recognize that the fastener may be simple enough to allow the luminance filtering assembly to be adjusted vertically and horizontally while the user is operating the vehicle. Those skilled in the art, in light of the present teachings will recognize that the luminance filtering assembly may be fabricated in formats that adhere to standards, including, without limitation, American National Standards Institute (ANSI) and Consumer Product Safety Commission (CPSC).

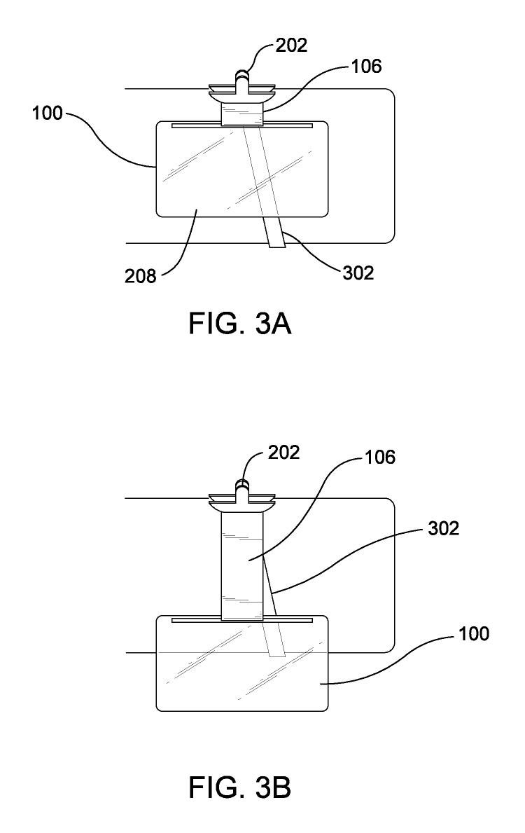

FIGS. 3A and 3B illustrate detailed perspective views of an exemplary luminance filtering assembly, in accordance with an embodiment of the present invention, where FIG. 3A illustrates an exemplary luminance filtering assembly extended a short vertical distance from an exemplary visor, and FIG. 3B illustrates an exemplary luminance filtering assembly extended a longer vertical distance from an exemplary visor. In the present embodiment, the translucent portion may join with the visor through a strap that supports the translucent portion. Suitable materials for the strap may include, without limitation, Naugahyde™, leather, nylon, polyester, and various blends of the above. In some embodiments, the strap may include a sufficient length to adjust the translucent portion in a vertical direction in relation to the visor. In this manner, the translucent portion may be adjusted to accommodate for different user heights, lines of sight, movement, and intensity of glares from luminance. In one embodiment of the present invention, the fastener may clamp down on the visor, and on a visor end of the strap to secure a desired vertical length for the translucent portion. In this manner, the translucent portion may position into an extended position for use. The fastener may include, without limitation, a spring-loaded clamp, a clip, a buckle, a snap, and a hook-and-loop material. Suitable materials for the fastener may include, without limitation, polyvinyl chloride, polyethylene terephthalate, high density polyethylene, metal, wood, and alloys. In some embodiments, the fastener may also serve to clamp into a closed position for pressing the translucent portion against the visor for storage in a retracted position.

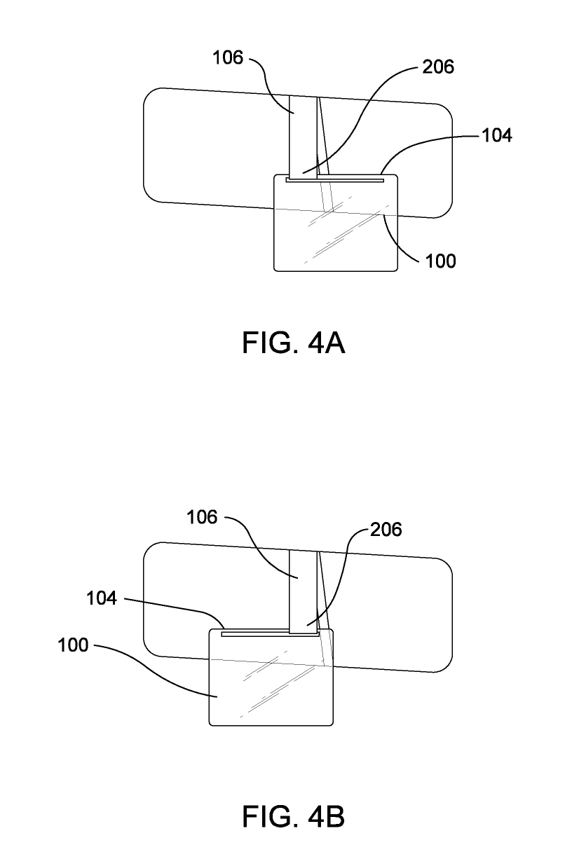

FIGS. 4A and 4B illustrate detailed perspective views of an exemplary luminance filtering assembly, in accordance with an embodiment of the present invention, where FIG. 4A illustrates an exemplary luminance filtering assembly adjusted horizontally to the left, and FIG. 4B illustrates an exemplary luminance filtering assembly adjusted horizontally to the right. In the present embodiment, the translucent portion may include the slot for receiving the translucent portion end of the strap. The translucent portion end may include a loop that is configured to wrap through the slot. In this manner, the translucent portion may be adjusted horizontally. In one embodiment, the translucent portion end of the strap may slide to the left or to the right to compensate for variable conditions. In one embodiment, the slot may include dimensions of 7″×⅛″, and be positioned approximately ½″ below a top edge of the translucent portion. However in other embodiments, the slot may include additional sizes and dimensions to accommodate greater or lesser horizontal adjustment needs and thicker straps. In one embodiment, the strap may include measurements of 4″×2″. However in other embodiments, larger or smaller straps may be utilized. In one alternative embodiment, the translucent portion end may slide to the left and right by remote controlled power.

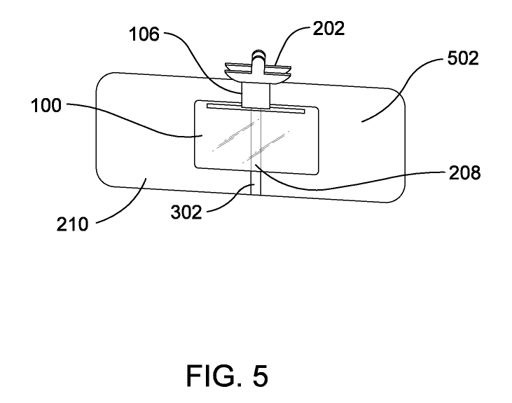

FIG. 5 illustrates a detailed perspective view of an exemplary luminance filtering assembly in a retracted position, in accordance with an embodiment of the present invention. In the present embodiment, the translucent portion may store in a retracted position while the visor is pressed against the ceiling of the vehicle. For storage, the fastener may press the translucent portion against the visor while the visor is pressed flat against a ceiling of the vehicle. This may include the retracted position for the translucent portion. In some embodiments, the translucent portion may also utilize the adhesive portion to secure to the visor strap, which wraps around the visor. The adhering portion may join with a compatible area of the visor strap to further secure the translucent portion against the visor. In one embodiment, the adhesive portion may include a one square half inch swatch of hook and loop (e.g., Velcro™) that adheres to a section of the visor strap fabricated from hooks and loops (e.g., Velcro™). However, in other embodiments, the adhesive portion may join with the visor strap through other fastening means, including, without limitation, buttons, magnets, glue, and snaps. The visor strap may be removed from the visor by detaching opposite ends. The opposite ends of the visor strap may reattach to wrap around the visor through various fastening means including, without limitation, hook and loop straps (e.g., Velcro™), buttons, glue, and snaps.

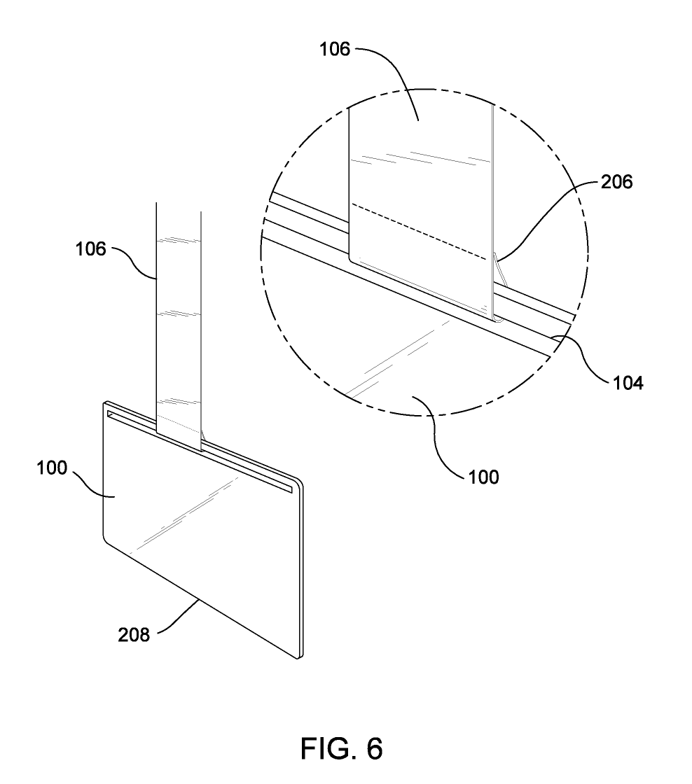

FIG. 6 illustrates a close up view of an exemplary translucent portion end of an exemplary strap looped around an exemplary slot, in accordance with an embodiment of the present invention. In the present embodiment, the strap may extend and include opposite ends to join the visor with the translucent portion. The strap may include a translucent portion end that forms a loop that wraps around the slot. In this manner, the translucent portion end may slide horizontally to adjust the translucent portion, while the strap remains substantially stationary.

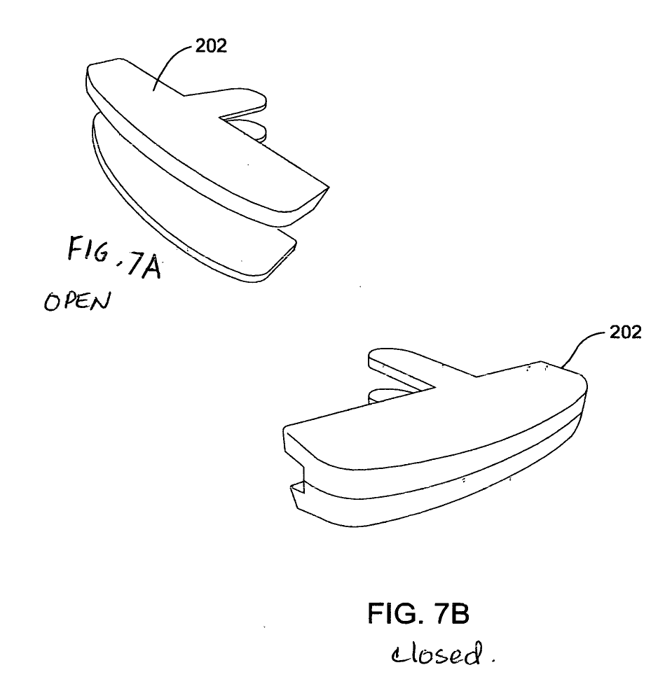

FIGS. 7A and 7B illustrate detailed perspective views of an exemplary fastener, in accordance with an embodiment of the present invention, where FIG. 7A illustrates an exemplary fastener in an open position, and FIG. 7B illustrates an exemplary fastener in a closed position. In the present embodiment, the fastener may clamp down on the visor, and on the visor end of the strap to secure a desired vertical length for the translucent portion. In this manner, the translucent portion may position into an extended position for use. However, in another embodiment, the fastener may press the translucent portion against the visor for storage while the visor is pressed flat against a ceiling of the vehicle. This may include the retracted position for the translucent portion. The fastener may include, without limitation, a spring-loaded clamp, a clip, a buckle, a snap, and a hook-and-loop material. Suitable materials for the fastener may include, without limitation, polyvinyl chloride, polyethylene terephthalate, high density polyethylene, metal, wood, and alloys.

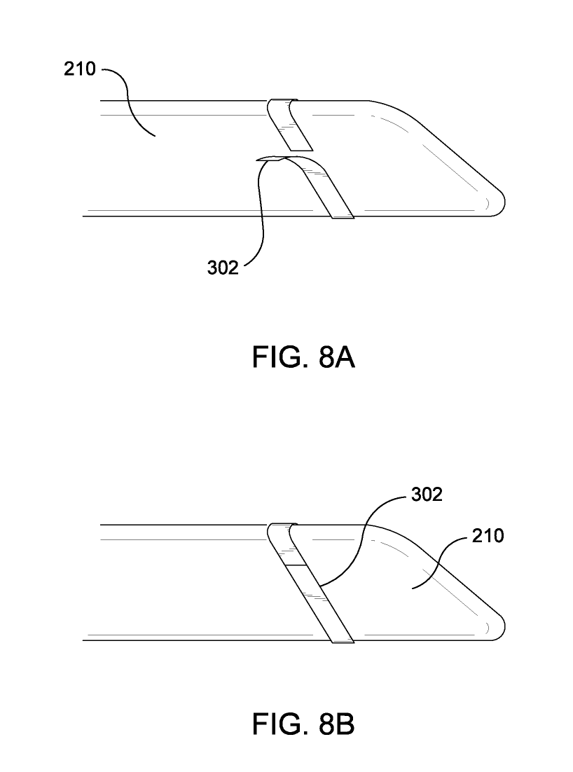

FIGS. 8A and 8B illustrate detailed perspective views of an exemplary visor strap, in accordance with an embodiment of the present invention, where FIG. 8A illustrates an exemplary visor strap in an open position, and FIG. 8B illustrates an exemplary visor strap in a closed position wrapped around an exemplary visor. In the present embodiment, the visor strap may wrap around the visor to provide an adhesive surface for the adhesive portion of the translucent portion to adhere to. The visor strap may be removed from the visor by detaching opposite ends. The opposite ends of the visor strap may reattach to wrap around the visor through various fastening means including, without limitation, hook and loop straps (e.g., Velcro™), buttons, glue, and snaps. The visor strap may include dimensions of 24″×1″. However larger or smaller visor straps may be utilized to accommodate different visors. It is contemplated that any vehicle with a visor could use the visor strap, such as a large tractor with cab. However, with vehicles with no visor, say for instance a boat, a different method might be more optimal. The strap from the tinted plastic piece could be folded over the window of a boat and the clip could be used to secure it in place. In this instance no visor strap is used. However, possibly suction cups and/or hook and loop (e.g., Velcro™) straps used in a different method.]

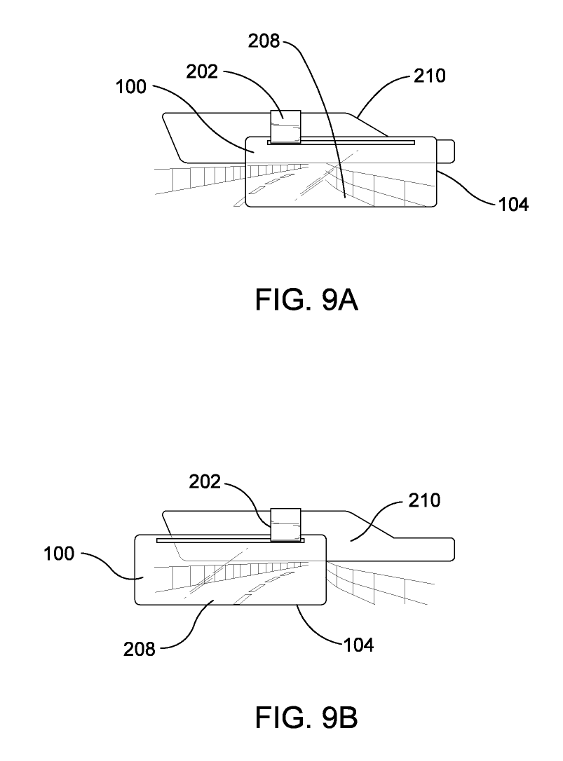

FIGS. 9A and 9B illustrate detailed perspective views of an exemplary luminance filtering assembly without a strap, in accordance with an embodiment of the present invention, where FIG. 9A illustrates an exemplary luminance filtering assembly adjusted horizontally to the right, and FIG. 9B illustrates an exemplary luminance filtering assembly adjusted horizontally to the left. In the present embodiment, the luminance filtering assembly may not require the strap to join the visor with the translucent portion. In one embodiment, the fastener may be configured to position through the slot in the translucent portion from one end, and clamp down on the visor from an opposite end. The end that passes through the slot may also slide horizontally to the left and right to provide lateral adjustment capabilities. Those skilled in the art, in light of the present teachings will recognize that the fastener in this embodiment may not provide vertical adjustment capabilities like the strap due to the fasteners more rigid, and shorter construction.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing adjustable luminance filtering for a vehicle according to the present invention will be apparent to those skilled in the art. Various aspects of the invention have been described above by way of illustration, and the specific embodiments disclosed are not intended to limit the invention to the particular forms disclosed. The particular implementation of the adjustable luminance filtering for a vehicle may vary depending upon the particular context or application. By way of example, and not limitation, the adjustable luminance filtering for a vehicle described in the foregoing were principally directed to an adjustable luminance filter that extends down form a vehicle visor and does not restrict vision implementations; however, similar techniques may instead be applied to skyscrapers that receive excessive sunlight which increases the air conditioning and energy costs, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims

What is claimed is:

1. A luminance filtering assembly comprising:
a translucent portion, said translucent portion being configured to help filter a luminance, said translucent portion being disposed to extend from a visor in an extended position, said translucent portion comprising a slot, said translucent portion further comprising an adhesive portion;
a strap, said strap being configured to join said translucent portion with said visor, said strap comprising a translucent portion end, said translucent portion end further being configured to join with said slot, said strap further comprising a visor end, said visor end being configured to join with said visor;
a fastener, said fastener being configured to press said translucent portion against said visor in a retracted position, said fastener being further configured to adjust a length of said strap in said extended position; and
a visor strap, said visor strap being configured to wrap around said visor, said visor strap being operable to join with said translucent portion in said retracted position.

2. The luminance filtering assembly of claim 1, in which said translucent portion comprises a plate of translucent polycarbonate material.

3. The luminance filtering assembly of claim 2, in which said translucent portion comprises a tint, said tint being configured to filter luminance to about 20% visible light transmission.

4. The luminance filtering assembly of claim 3, wherein said translucent portion is disposed to extend from said visor to a line of sight.

5. The luminance filtering assembly of claim 4, wherein said translucent portion is operable to adjust horizontally and vertically.

6. The luminance filtering assembly of claim 5, wherein said slot is operable to provide horizontal movement for said translucent portion.

7. The luminance filtering assembly of claim 6, in which said translucent portion end comprises a loop for securing to said slot.

8. The luminance filtering assembly of claim 7, wherein said strap is configured to vertically adjust the proximity of said translucent portion to said visor.

9. The luminance filtering assembly of claim 8, in which said fastener is operable to vertically adjust the proximity of said translucent portion to said visor.

10. The luminance filtering assembly of claim 9, in which said fastener comprises a spring loaded tension clip.

11. The luminance filtering assembly of claim 10, wherein said fastener is operable to be detachable from said visor.

12. The luminance filtering assembly of claim 11, in which said adhesive portion comprises a hook and loop material, said hook and loop material comprising Velcro™.

13. The luminance filtering assembly of claim 12, in which said visor strap comprises a hook and loop material, said hook and loop material comprising Velcro™.

14. The luminance filtering assembly of claim 13, wherein said adhesive portion is operable to join with said visor strap in said retracted position.

15. The luminance filtering assembly of claim 14, in which said adhesive portion comprises a one square half inch swatch of Velcro™.

16. The luminance filtering assembly of claim 15, wherein said adhesive portion permanently joins with said translucent portion with a two-part epoxy.

17. The luminance filtering assembly of claim 16, in which said fastener joins said slot with said visor without said strap.

18. The luminance filtering assembly of claim 17, in which said translucent portion comprises at least one flap, said at least one flap being configured to extend the area of the translucent portion for filtering luminance.

19. A method for restricting a light luminance comprising:
means for securing a translucent portion to a visor in a retracted position;
means for detaching an adhesive portion from a visor strap;
means for extending said translucent portion to an extended portion;
means for vertically adjusting said translucent portion with a strap;
means for horizontally adjusting said translucent portion with a slot; and
means for filtering luminance.

20. A luminance filtering assembly consisting of:
a translucent portion, said translucent portion being configured to help filter a luminance, said translucent portion comprising a plate of translucent polycarbonate material, said translucent material further comprising a tint, said translucent portion further comprising a slot, said translucent portion further comprising an adhesive portion, said translucent portion being disposed to extend from a visor in an extended position;
a strap, said strap being configured to join said translucent portion with said visor, said visor comprising a vehicle visor, said strap comprising a translucent portion end, said translucent portion end comprising a loop, said loop being configured to wrap around said slot, said translucent portion end further being configured to join with said slot, said strap further comprising a visor end, said visor end being configured to join with said visor, said strap being operable to adjust said translucent portion horizontally and vertically;
a fastener, said fastener comprising a clip, said fastener being configured to press said translucent portion against said visor in a retracted position, said fastener being further configured to adjust a length of said strap in said extended position; and
a visor strap, said visor strap being configured to wrap around said visor, said visor strap being operable to join with said translucent portion in said retracted position.
